(19) United States
(12) Patent Application Publication
(10) Pub. No.: US 2016/0120144 A1
(43) Pub. Date: May 5, 2016

(54) LIVESTOCK HOUSE MANAGEMENT SYSTEM AND MANAGEMENT METHOD THEREOF

(71) Applicant: ELECTRONICS AND TELECOMMUNICATIONS RESEARCH INSTITUTE, Daejeon (KR)

(72) Inventors: Keo Sik KIM, Gwangju (KR); Hyun Seo KANG, Gwangju (KR); Seung Hun OH, Gwangju (KR); Jeong Eun KIM, Gwangju (KR); Ji Hyoung RYU, Jeonju-si (KR); Hyoung Jun PARK, Gwangju (KR); Kwon Seob LIM, Gwangju (KR); Eun Kyoung JEON, Gwangju (KR); Young Soon HEO, Gwangju (KR)

(73) Assignee: ELECTRONICS AND TELECOMMUNICATIONS RESEARCH INSTITUTE, Daejeon (KR)

(21) Appl. No.: 14/825,919

(22) Filed: Aug. 13, 2015

(30) Foreign Application Priority Data
Oct. 30, 2014 (KR) 10-2014-0149276

(51) Int. Cl. A01K 1/00; A01K 31/20

(52) U.S. Cl. CPC A01K 1/0047; A01K 1/0052; A01K 31/20

(57) ABSTRACT

Provided is a livestock house management system for managing a rearing environment of livestock. The livestock house management system includes an environment monitoring sensor unit installed in each of divided zones within a livestock house and configured to measure an environment variable indicating a state of a rearing environment of each of the zones, analyze the measured environment variable, and independently generate a command corresponding to an abnormal situation of each of the zones when the abnormal situation of each of the zones is checked, and a livestock house facility control unit installed in each of the zones and configured to receive the command from the environment monitoring sensor unit installed in a corresponding zone according to a wired or wireless communication scheme, and drive a livestock house facility according to the received command to independently control a rearing environment of each of the zones.

### CROSS-REFERENCE TO RELATED APPLICATIONS

This application claims priority under 35 U.S.C. §119 to Korean Patent Application No. 10-2014-0149276, filed on Oct. 30, 2014, the disclosure of which is incorporated herein by reference in its entirety.

### TECHNICAL FIELD

The present invention relates to a livestock house management system and a management method thereof, and more particularly, to a livestock house management system and a management method thereof for maintaining a rearing environment of livestock in an optimal state and appropriately handling an abnormal situation as sensed.

### BACKGROUND

An environment of a livestock house directly affects rearing of livestock, and thus, appropriate temperature, humidity, and illuminance need to be maintained. Also, appropriate measures such as ventilation, or the like, should be taken according to a concentration of a harmful gas within a livestock house, and thus, a means for constantly monitoring various environment variables indicating a rearing environment of the livestock house should be established.

However, monitoring environment variables by a manager around the clock has a substantial limitation. Thus, a livestock house management system including a monitoring device and a control unit to sense an environment of a livestock house and automatically operate livestock house facilities according to a determined schedule and handle an abnormal situation as sensed is required.

In the related art livestock house management system mostly relates to techniques of simply monitoring a rearing environment within a livestock house and driving livestock house facilities according to the monitoring results to remove risky factors obstructing the rearing of livestock or monitoring a livestock environment from a remote area.

Also, since most facilities of the livestock house are manually operated by managers, the related art livestock house management system cannot properly cope with an abnormal situation when a harmful gas is detected or when the harmful gas is rapidly increased due to a high temperature and humidity.

In addition, in the related art livestock house management system, a server and sensors are disposed according to a central controlling scheme (1 (server): N (sensors) manner), and thus, the single server should collect sensed values from N number of sensors, process the collected sensed values, and directly drive each of livestock house facilities.

As a result, as the number sensors and facilities to be controlled by the single server increases, a load of the server is added, and thus, when an abnormal situation is sensed due to a processing delay or an error resulting from the overloaded server, it is difficult to appropriately cope with the situation.

In addition, the trend of large livestock houses makes it difficult to optimally operating a livestock house by reflecting environment information of each zone, and it is difficult to immediately sense information regarding a livestock house environment.

In addition, a high-rise poultry house devised to discharge livestock waste to the outside of a livestock house does not provide a scheme for solving the foregoing problems.

### SUMMARY

Accordingly, the present invention provides a livestock house management system for managing a livestock rearing environment of a livestock house by using a distributed control scheme of distributing a load of a server to reduce an overload of the server according to the related art central control scheme, and appropriately handling an abnormal situation as occurs, an a management method thereof.

The present invention also provides a livestock house management system for handling livestock waste by automatically driving a scraper when an excessive amount of harmful gas is sensed according to continuous monitoring of the harmful gas in a livestock house having a high-rise poultry house structure.

In one general aspect, a livestock house management system for managing a rearing environment of livestock includes: an environment monitoring sensor unit installed in each of divided zones within a livestock house and configured to measure an environment variable indicating a state of a rearing environment of each of the zones, analyze the measured environment variable to check whether an abnormal situation of each of the zones occurs, and independently generate a command corresponding to the abnormal situation of each of the zones when the abnormal situation of each of the zones is checked; and a livestock house facility control unit installed in each of the zones and configured to receive the command from the environment monitoring sensor unit, installed in a corresponding zone according to a wired or wireless communication scheme, and drive a livestock house facility according to the received command to independently control a rearing environment of each of the zones.

In another general aspect, a livestock house management method for managing a rearing environment of livestock includes: measuring, by an environment monitoring sensor unit installed in each of divided zones within a livestock house, an environment variable indicating a rearing environment situation of each of the zones; analyzing, by the environment monitoring sensor unit installed in each of the zones, the measured environment variable and determining whether each of the zones is in an abnormal situation; when the environment monitoring sensor unit determines the abnormal situation, generating a command to handle the abnormal situation and transmitting the command to a livestock house facility control unit installed in each of the zones; and receiving, by the livestock house facility control unit, the command, and driving a livestock house facility according to the received command to independently control a rearing environment of each of the zones.

Other features and aspects will be apparent from the following detailed description, the drawings, and the claims.

### BRIEF DESCRIPTION OF THE DRAWINGS

FIG. 1 is a view illustrating a configuration of a system for managing a livestock house according to an embodiment of the present invention.

FIG. 2 is a block diagram illustrating a configuration of an environment monitoring sensor unit illustrated in FIG. 1.

FIG. 3 is a block diagram illustrating an internal configuration of a livestock house facility control unit illustrated in FIG. 1.

FIG. 4 is a view illustrating a communication interface of each component illustrated in FIG. 1.

FIG. 5 is a flow chart illustrating a method for managing a livestock house using a livestock house management system according to an embodiment of the present invention.

FIGS. 6A and 6B are a flow chart illustrating a process of driving a livestock house facility illustrated in FIG. 5.

### DETAILED DESCRIPTION OF EMBODIMENTS

The present invention relates to a livestock house management system having a high-rise poultry house structure and a management method thereof, and more particularly, provides a scheme of constantly monitoring an environment of a livestock house by using various environment sensors, maintaining an environment of a livestock house in an optimal state by controlling livestock facilities in a distributed manner, and appropriately handling an abnormal situation as sensed.

Hereinafter, embodiments of the present invention will be described in detail with reference to the accompanying drawings.

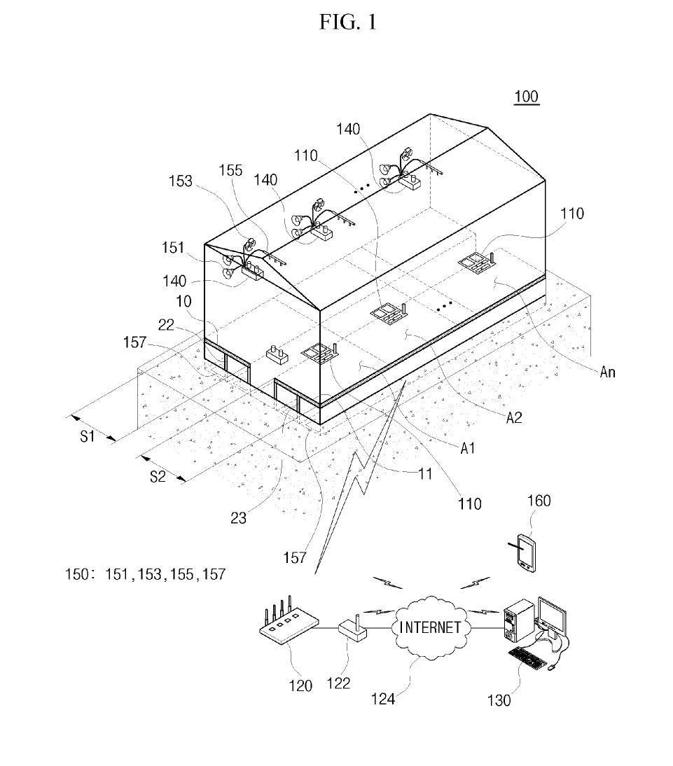

FIG. 1 is a view illustrating a configuration of a system for managing a livestock house according to an embodiment of the present invention.

Referring to FIG. 1, a livestock house management system 100 according to an embodiment of the present invention controls various livestock house facilities within a high-rise poultry house according to a distributed control scheme, thus maintaining a livestock rearing environment of the high-rise poultry house in optimal conditions.

In the high-rise poultry house to which the livestock house management system 100 according to an embodiment of the present invention is applied, a livestock rearing space for rearing livestock is divided into first and second rearing spaces S1 and S2 with respect to the center of the livestock house, and each of the first and second rearing spaces S1 and S2 is divided into a plurality of rearing zones A1, A2, . . . , An.

In each of the rearing spaces S1 and S2, a first mesh screen 10 and a second mesh screen 11 are installed to be spaced apart from the floor of the livestock house by a predetermined height, respectively. The first mesh screen 10 and the second mesh screen 11 have a mesh structure, and the mesh structure allows livestock waste to be easily dropped to the floor of the livestock house.

A space between the floor of the livestock house and the first mesh screen 10 is divided into two spaces by a support bar 22 supporting the first mesh screen 10, and a scraper for removing livestock waste dropped through the first mesh screen 10 is installed on the floor of the space in each of the plurality of rearing zones A1, A2, . . . , An.

Similarly, a space between the floor of the livestock house and the second mesh screen 11 is divided into two spaces by a support bar 23 supporting the second mesh screen 11, and a scraper for removing livestock waste dropped through the second mesh screen 11 is installed on the floor of the space in each of the plurality of rearing zones A1, A2, . . . , An.

The livestock house management system according to an embodiment of the present invention applied to the aforementioned high-rise poultry house includes an environment monitoring sensor unit 110, a remote terminal unit 120, a central server unit 130, a livestock house facility control unit 140, livestock house facilities 150, and a Web server unit 160.

The environment monitoring sensor unit 110 is installed in each of the rearing zones A1, A2, . . . , An within the livestock house, monitors a livestock house rearing environment of each of the zones A1, A2, . . . , An using a plurality of environment monitoring sensors, and transmits the monitored environment information to the remote terminal unit 120 through wireless network composed of ZigBee™, Wi-Fi, Bluetooth™, and a combination thereof. The environment monitoring sensor may include a temperature sensor for monitoring an internal temperature of the livestock house according to environment variables, a humidity sensor for monitoring internal humidity of the livestock house, a carbon dioxide sensor for measuring a concentration of carbon dioxide within the livestock house, an ammonia sensor for measuring a concentration of ammonia within the livestock house, a differential pressure sensor for monitoring an internal pressure distribution of the livestock house, and an illumination sensor for measuring internal brightness of the livestock house. Here, the internal pressure distribution measured by the differential pressure sensor is used for the purpose of monitoring density or distribution of livestock living in a compact mass in a predetermined zone within the livestock house. Some domestic animals such as chicken tend to live in a compact mass in a predetermined zone within the livestock house, and there is a risk of being crushed in a zone with high density. In a zone with high density, a respiration volume of domestic animals per unit area is so large that pressure increases, compared with other zone with low density.

The differential pressure sensor monitors density of domestic animals by continuously monitoring a change in pressure of each zone, and the monitoring results may be used to adjust an entity distribution by actuating a livestock house facility such as a ventilator.

Meanwhile, the six types of sensors are mentioned as the environment monitoring sensor, but the present invention is not limited thereto and various other sensors such as an infrared camera sensor, a harmful gas sensor, a wind volume sensor, and a wind velocity sensor may be used according to environment variables.

The remote terminal unit 120 receives the environment information measured by the environment monitoring sensor unit 110 through wireless network such as ZigBee™ or Wi-Fi and transmits the received environment information to the Internet access unit 122 accessible to the wireless/wired Internet 124, and the Internet access unit 122 transmits the environment information received from the remote terminal unit 120 to the central server unit 130 or the Web server unit 160 through the Internet 124. Here, the Internet access unit 122 may be an access point serving as a bridge connecting a weird Internet and a wireless Internet, or may be a router or a switch.

The central server unit 130 collects the environment information received through the wired/wireless Internet 124, analyzes the collected environment information, and provides analysis results to a manager or determines whether a situation within the livestock house is abnormal from the analysis results. When the situation within the livestock house is determined to be abnormal, the central server unit 130 generates a command for driving a livestock house facility within the livestock house, and transmits the generated command to the environment monitoring sensor unit 110 through a transmission path including the wired/wireless Internet 124, the Internet access unit 122, and the remote terminal unit 120. The environment monitoring sensor unit 110 transmits the command received from the central server unit 130 to the livestock house facility control unit 140 through wired/wireless communication.

The livestock house facility control unit 140 is installed in each of the rearing zones A1, A2, . . . , An within the livestock house, generates a driving command for driving the livestock house facilities 150 according to the command received from the environment monitoring sensor unit 110 installed in a corresponding zone, and applies the generated driving command to the livestock house facilities 150.

The livestock house facilities 150 include a lighting system 151, a ventilating fan 153, a spray 155, and a scraper 157 driven according to the driving command transferred from the livestock house facility control unit 140.

In order to allow for monitoring the livestock house rearing environment from a remote area, the Web server unit 160 accesses the central server unit 130, reads information, and provides the read information to a manager, and generates a command for controlling the livestock house facilities 150 by the manager and transmits the generated command to the livestock house facility control unit 140.

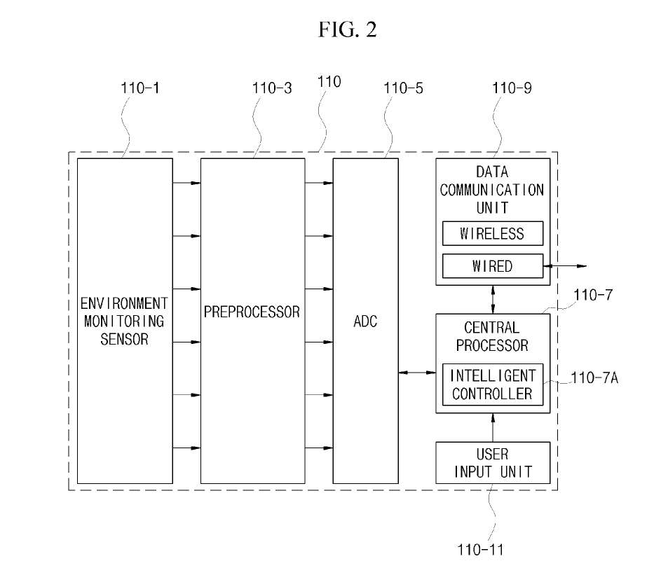

FIG. 2 is a block diagram illustrating a configuration of the environment monitoring sensor unit illustrated in FIG. 1.

Referring to FIG. 2, the environment monitoring sensor unit 110 may include an environment monitoring sensor 110-1, a preprocessor 110-3, an analog-to-digital converter (ADC) 110-5, a central processor 110-7, a data communication unit 110-9, and a user input unit 110-11.

As mentioned above, the environment monitoring sensor 110-1 measures a rearing environment within the livestock house, for example, a temperature value, a humidity value, a carbon dioxide concentration value, an ammonia concentration value, a pressure value per unit area, and an illuminance value, and outputs the measurement results as an analog signal.

The preprocessor 110-3 may include a filter circuit for canceling noise included in an analog signal measured by the sensor 110-1 and an amplifying circuit for amplifying the analog signal. The filter circuit includes a 60 Hz notch filter for removing power noise and a harmonic component, a low-pass filter, and a high-pass filter for removing a drift of a DC component of the analog signal. As a cut-off frequency and an amplification factor of each filter circuit, various values may be used according to user purposes.

The ADC 110-5 converts the measured analog signal into a digital signal and periodically transfers the converted digital signal to the central processor 110-7. Here, as a sampling frequency, a resolution, and a measurement period used for conversion into the digital signal, various values may be used according to user purposes and characteristics of a used sensor.

The central processor 110-7 converts the received digital signal into an actually sensed value using a conversion algorithm stored therein. For example, in a case where the central processor 110-7 converts the digital signal corresponding to the temperature sensor into an actually sensed value and uses an algorithm expressed as a temperature conversion formula such as y=10x+5 (y: temperature value, x: voltage measured by the temperature sensor), when the central processor 110-7 receives a digital signal having a measurement voltage 1.5V, the central processor 110-7 converts the digital signal having the measurement value 1.5V into a final temperature measurement value of 20° C. according to the temperature conversion formula.

Also, in order to transfer environment information such as the converted final temperature measurement value to the central server unit 130, the central processor 110-7 converts the final temperature measurement value into a command according to a communication interface and a protocol and transfers the converted command to the data communication unit 110-9.

The data communication unit 110-9 configures the command transferred from the central processor 110-7 into a packet for data communication in conformity with a preset communication standard, and transfers the configured packet for data communication to the remote terminal unit 120 of FIG. 1. Here, as a sensor connection protocol used between the data communication unit 110-9 and the remote terminal unit 120, an IETF CoAP protocol, the Internet of things (IoT) communication standard, is used, and the communication interface performs communication between a sensor unit and a server or between sensor units using ZigBee™ communication. In this embodiment, a CoAP protocol is used as the sensor connection protocol, but in addition to this, various other protocols such as Sensor Web, IPv6 or 6LowPAN may be used. Also, in this embodiment, ZigBee™, a wireless standard, is used as the communication interface, but in addition to this, various other wired standard such as RS-232, RS-485, or GBIP and various wireless standards such as Wi-Fi, Bluetooth™, NFC, RF, infrared communication, and Li-Di may also be used.

The central processor 110-7 determines a rearing environment state using the sensed environment information, and when an abnormal situation is sensed, the central processor 110-7 generates a command for driving a livestock house facility according to a previously scheduled environment-handling process, and transfers the generated command to the livestock house facility control unit 140 and the central server unit 130 through the data communication unit 110-9.

In order to share an existing role of the central server unit 130 determining a rearing environment condition, the central processor 110-7 may include an intelligent controller 110-7A determining a rearing environment condition from environment information. The intelligent controller 110-7A may include a fuzzy controller, a neural network controller, a PID controller, and the like, and may be configured as various controllers fitting user purposes.

The user input unit 110-11, a component for controlling operations of components included in the environment monitoring sensor unit 110, performs an operation such as power ON/OFF, device resetting, and the like, according to a user input.

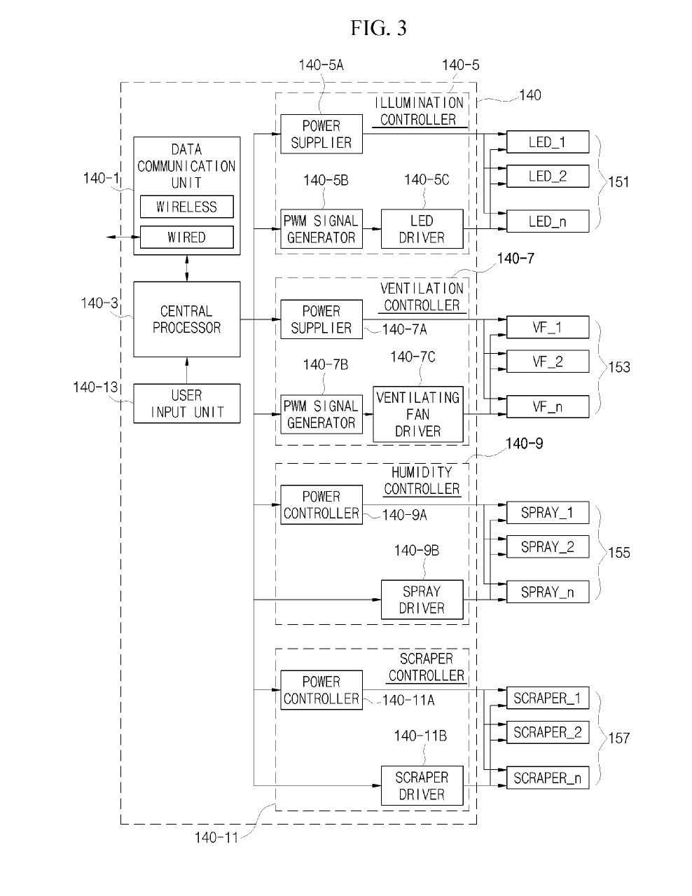

FIG. 3 is a block diagram illustrating an internal configuration of the livestock house facility control unit illustrated in FIG. 1.

Referring to FIG. 3, the livestock house facility control unit 140 includes a data communication unit 140-1, a central processor 140-3, an illumination controller 140-5, a ventilation controller 140-7, a humidity controller 140-9, a scraper controller 140-11, and a user input unit 140-13.

The data communication unit 140-1 extracts a command from the data communication (ZigBee™) packet transferred from the environment monitoring sensor unit 110 according to a preset communication protocol (CoAP), and transfers the command to the central processor 140-3.

The central processor 140-3 generates a command for driving a livestock house facility 150 (151, 153, 155, and 157) according to the command transferred from the environment monitoring sensor unit, and transfers the generated command to the controllers 140-5, 140-7, 140-9, and 140-11.

It is assumed that the illumination controller 140-5 drives the lighting system 151 according to a command received from the central processor 140-3, and specifically, it is assumed that the illumination controller 140-5 drives an LED lighting system but without being particularly limited. The illumination controller 140-5 includes a power supplier 140-5A supplying a driving voltage for driving LED lighting systems 151 (LED_1, LED_2, . . . , LED_n), a pulse width modulation (PWM) signal generator 140-5B generating a pulse signal with reference to a look-up table for controlling illuminance, a color temperature, and dimming of the lighting system 151, and an LED driver 140-5C controlling illuminance, a color temperature, and dimming of the LED lighting systems 151 (LED_1, LED_2, . . . , LED_n) according to the pulse signal.

The ventilation controller 140-7 drives ventilating fans (VF) 153 (VF_1, VF_2, . . . , VF_n) according to a command received from the central processor 140-3, and to this end, the ventilation controller 140-7 includes a power supplier 140-7A supplying a driving voltage for driving the ventilating fans 153 (VF_1, VF_2, . . . , VF_n), a PWM signal generator 140-7B generating a pulse signal for controlling a rotation speed and torque of the ventilating fans 153 (VF_1, VF_2, . . . , VF_n), and a ventilating fan driver 140-7C controlling a rotation speed and torque of the ventilating fans 153 (VF_1, VF_2, . . . , VF_n) according to the pulse signal.

The humidity controller 140-9 drives a spray according to a command received from the central processor 140-3, and to this end, the humidity controller 140-9 includes a power supplier 140-9A supplying a driving voltage for driving a spray and a spray driver 149-9B controlling driving of the spray.

The scraper controller 140-11 drives a scraper according to a command received from the central processor 140-3. To this end, the scraper controller 140-11 includes a power supplier 140-11A supplying a driving voltage for driving a scraper and a scraper driver 140-11B controlling driving of the scraper.

The illumination controller 140-5, the ventilation controller 140-7, the humidity controller 140-9, and the scraper controller 140-11 may additionally include components such as a relay circuit, a power protecting circuit, or a switching circuit according to a facility (LED, ventilating fan, sprayer, scraper, etc.) in use.

The user input unit 140-13 performs an operation such as power ON/OFF, device resetting, and the like, according to a user input.

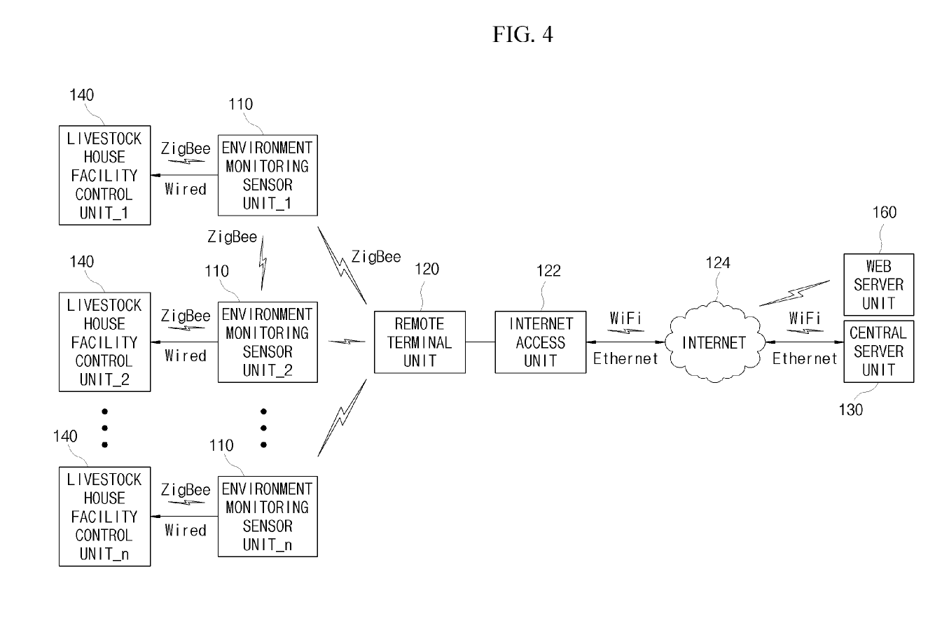

FIG. 4 is a view illustrating a communication interface of each component illustrated in FIG. 1.

Referring to FIG. 4, the livestock house management system 100 illustrated in FIG. 1 manages a rearing environment of the livestock house according to a distributed control scheme, and to this end, the environment monitoring sensor units 110 and the livestock house facility control units 140 are disposed in a distributed manner in the plurality of rearing zones A1, A2, . . . , An within the livestock house, and monitor an environment and independently control a facility disposed in each zone.

As a communication interface between the environment monitoring sensor unit 110 and the livestock house facility control unit 140, a wireless communication standard such as ZigBee™, or the like, or a wired communication standard such as RS-485 or GPIB may be used in order to reduce power consumption and a work load.

As a communication interface between the environment monitoring sensor units and a communication interface between the environment monitoring sensor unit 110 and the remote terminal unit 120, a wireless standard such as ZigBee™, or the like, is used.

A communication interface between the remote terminal unit 120 and the central server unit 130 uses an Internet communication infrastructure such as Wi-Fi or Ethernet, and a communication interface between the remote terminal unit 120 and the Web server unit 160 may use an Internet communication infrastructure including a Wi-Fi standard.

As a sensor connection protocol for data communication between the remote terminal unit 120 and the module 110, an IETF CoAP protocol, an IoT communication standard, or an Sensor Web protocol is used, and in addition to the scheme of using the CoAP protocol as a sensor connection protocol, various other protocols such as IPv6 or 6LowPAN may be used.

Also, in this embodiment, the wireless standard ZigBee™ is used as a communication interface, but in addition to this, various wired standards such as RS-232, RS-485, or GBIP and various wireless standards such as Wi-Fi, Bluetooth™, RF, or infrared communication may be used.

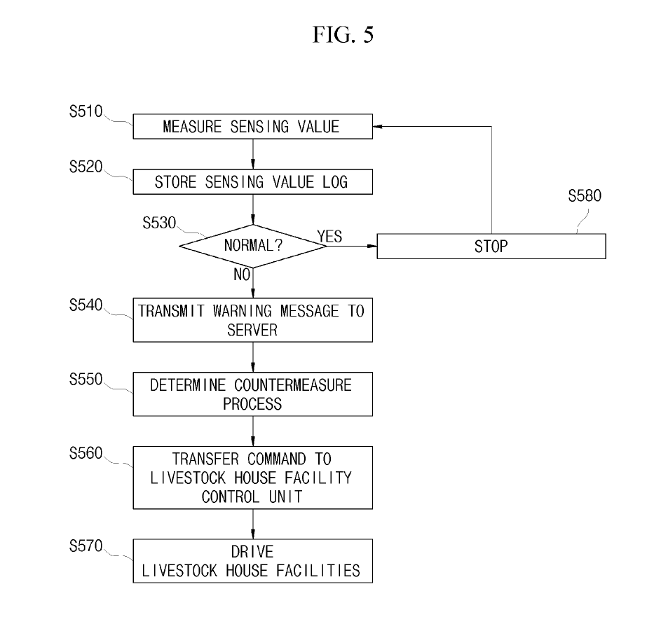

FIG. 5 is a flow chart illustrating a method for managing a livestock house using a livestock house management system according to an embodiment of the present invention. In order to help understand, the method for managing a livestock house will be described with reference to FIG. 1 together.

Referring to FIG. 5, first, in order to constantly monitor a rearing environment of the zones A1, A2, . . . , An, the environment monitoring sensor unit 110 measures sensing values including a temperature value, a humidity value, a carbon dioxide concentration value, an ammonia concentration value, a pressure value, and an illuminance value within the livestock house in step S510.

Next, the environment monitoring sensor unit 110 stores the measured sensing values in a log format in a memory installed in each sensor unit 110 in step S520.

Thereafter, the intelligent controller 110-7A of each sensor unit 110 determines whether a livestock house rearing environment is normal by using the measured sensing values in step S530.

When an abnormal situation is sensed according to the determination result, each sensor unit 110 transmits a warning message corresponding to the sensed results to the central server unit 130 in step S540. Here, each sensor unit 110 merely transfers the warning message as a means for a log record regarding the abnormal situation to the central server unit 130, rather than transmitting every environment information regarding the sensed abnormal situation to the central server unit 130. Thus, unlike an existing central server, the central server unit 130 according to an embodiment of the present invention does not perform an operation such as sensing an abnormal situation and generating every type of command for controlling the livestock house facilities according to the sensing results. That is, the central processor 110-7A (or an intelligent controller) installed in the environment monitoring sensor unit 110 of each divided zone within the livestock house performs the work of the existing central server and independently controls a facility of a corresponding zone according to a preset handling process, thereby considerably reducing a work load of the central server.

Thereafter, the intelligent controller 110-7A of each sensor unit 110 determines a preset handling process according to types of the livestock house facilities 150 (151, 153, 155, and 157) in step S550.

Thereafter, the intelligent controller 110-7A of each sensor unit 110 generates a command according to the determined handling process and transfers the generated command to the livestock house facility control unit in step S560, and the livestock house facility control unit drives a livestock house facility corresponding to a control target according to the received command in steep S570. Here, while the livestock house facility is being driven, each sensor unit continuously measures sensing values regarding the rearing environment, and continuously drives the livestock house facility until when a normal value indicating a normal condition of the rearing environment is checked from the continuously measured sensing values.

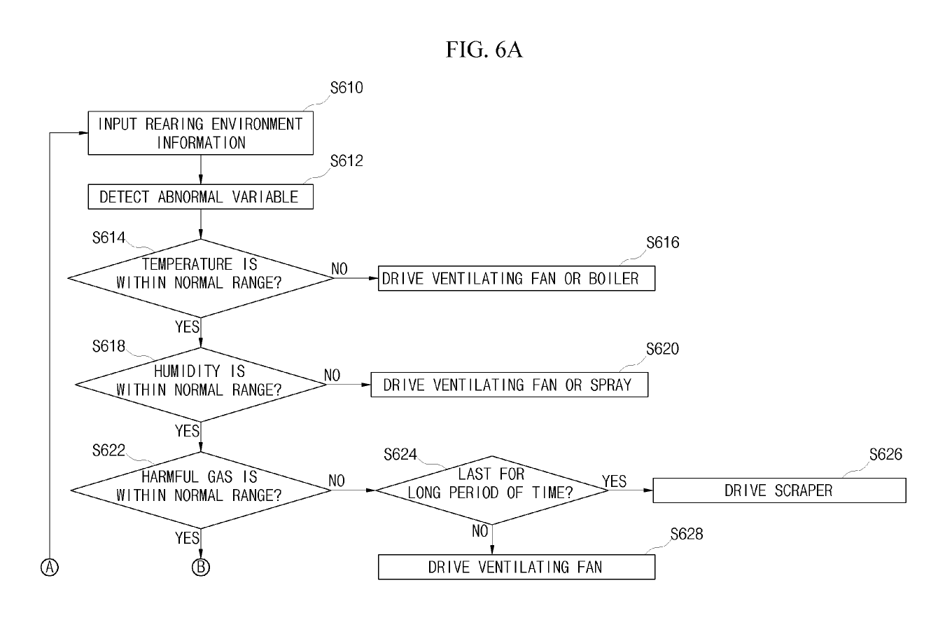

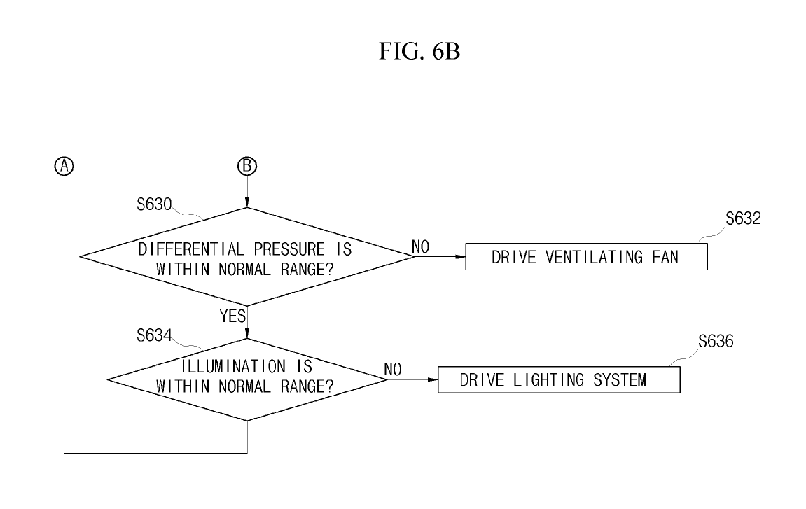

FIGS. 6A and 6B are a flow chart specifically illustrating a process of driving a livestock house facility illustrated in FIG. 5, in which a handling process regarding an abnormal situation checked in the rearing environment within the livestock house is illustrated.

Referring to FIGS. 6A and 6B, first, the intelligent controller 110-7A installed in the central processor 110-7 of the environment monitoring sensor unit 110 receives rearing environment information including environment variables such as a temperature value, a humidity value, a carbon dioxide concentration value, an ammonia concentration value, a pressure value, and an illuminance value in step S610.

Subsequently, the intelligent controller 110-7A detects an abnormal variable which is not within a normal range according to a proportional integral derivative (PID) control scheme in step S612, and drives a corresponding livestock house facility 150 according to the detected abnormal variable in steps S614 to S636.

In detail, the intelligent controller 110-7A determines whether a temperature value, among the measured environment variables, is within the normal rage in step S614, and when the temperature value is not within the normal range, the intelligent controller 110-7A drives the ventilating fan or a boiler in step S616. For example, when an internal temperature of the livestock house exceeds a maximum temperature within the normal range, the intelligent controller 110-7A drives the ventilating fan, and when an internal temperature of the livestock house is less than a minimum temperature within the normal range, the intelligent controller 110-7A drives the boiler.

Subsequently, when the temperature value is within the normal range, the intelligent controller 110-7A determines whether a humidity value, among the measured environment variables, is within the normal range in steep S618, and when the humidity value is not within the normal range, the intelligent controller 110-7A drives the ventilating fan or the spray in step S620. For example, when the humidity value exceeds a maximum value of the normal range, the intelligent controller 110-7A drives the ventilating fan, and when the humidity value is less than a minimum value of the normal range, the intelligent controller 110-7A drives the spray.

Subsequently, when the humidity value is within the normal range, the intelligent controller 110-7A determines whether a concentration value of a harmful gas, among the measured environment variables, is within the normal range in step S622, and when the concentration value is not within the normal range, the intelligent controller 110-7A drives the ventilating fan or the scraper in step S626 and S628. For example, when the concentration value of the harmful gas exceeds a maximum value of the normal range and the abnormal concentration value of the harmful gas lasts for a long period of time greater than a preset period of time, the intelligent controller 110-7A drives the scraper to remove livestock waste in step S626. When the abnormal concentration value of the harmful gas lasts for less than the preset period of time, the intelligent controller 110-7A drives the ventilating fan in step S628.

Subsequently, when the concentration value of the harmful gas is within the normal range, the intelligent controller 110-7A determines whether the differential pressure value, among the measured environment variables, is within a normal range in step S630, and when the measured differential pressure value is not within the normal range, the intelligent controller 110-7A drives the ventilating fan in step S632.

Subsequently, when the measured differential pressure value is within the normal range, the intelligent controller 110-7A determines whether the illuminance value, among the measured environment variables, is within a normal range in step S634. When the measured illuminance value is not within the normal range, the intelligent controller 110-7A drives the lighting system in step S636. For example, when the measured illuminance value exceeds a maximum value within the normal range, the intelligent controller 110-7A turns off the lighting system or drives the lighting system to lower the illuminance value, and when the measured illuminance value is less than a minimum value of the normal range, the intelligent controller 110-7A turns on the lighting system or drives the lighting system to increase the illuminance value.

As described above, in the detailed description of the present invention, a specific embodiment has been described. However, the embodiment may b variously modified within the scope of the present invention. For example, a user may monitor a rearing environment and directly drive a livestock facility. In this case, the environment monitoring sensor unit 110 may sense environment information, store the sensed value in a log file, and transfer the sensed value to the central server 130. Then, on the basis of the environment information received from the environment monitoring sensor unit 110, the central server 130 may determine whether a situation is abnormal, and when it is determined that the situation is abnormal, the central server unit 130 may directly generate a command for controlling each livestock house facility and transmit the command to the livestock house facility control unit 140 through the environment monitoring sensor unit 110, and the livestock house facility control unit 140 may drive each livestock house facility according to the command directly transmitted from the central server unit 130. Thus, the technical concept of the present invention is not limited to the foregoing embodiment of the present invention and should be determined by those equivalent to claims, as well as claims.

According to the present invention, since the rearing environment within the livestock house and various livestock house facilities are divided by zones and individually controlled, a large livestock house can be systematically operated and optimally controlled, and since a livestock house environment is constantly monitored, a ripple effect of an abnormal situation as occurs may be minimized.

Also, in the high-rise poultry house having a structure in which a livestock housing space hangs up in a predetermined height from the floor of the livestock house, livestock waste in the livestock house that may cause generation of a gas is completely removed by automatically operating a scraper installed in the floor of the livestock house, more agreeable livestock house environment may be provided.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A livestock house management system for managing a rearing environment of livestock, the livestock house management system comprising:
an environment monitoring sensor unit installed in each of divided zones within a livestock house and configured to measure an environment variable indicating a state of a rearing environment of each of the zones, analyze the measured environment variable to check whether an abnormal situation of each of the zones occurs, and independently generate a command corresponding to the abnormal situation of each of the zones when the abnormal situation of each of the zones is checked; and
a livestock house facility control unit installed in each of the zones and configured to receive the command from the environment monitoring sensor unit, installed in a corresponding zone according to a wired or wireless communication scheme, and drive a livestock house facility according to the received command to independently control a rearing environment of each of the zones.

2. The livestock house management system of claim 1, wherein the environment monitoring sensor unit comprises:
an environment monitoring sensor configured to measure the environment variable including at least one of a temperature value, a humidity value, a concentration value of a harmful gas, a pressure value per unit area and an illuminance value;
a central processor configured to generate a command corresponding to the abnormal situation; and
a data communication unit configured to transmit the command to the livestock house facility control unit according to a wireless communication scheme.

3. The livestock house management system of claim 2, wherein the central processor generates the command for driving the livestock house facility according to a previously scheduled environment handling process.

4. The livestock house management system of claim 2, wherein the environment monitoring sensor includes at least one of a temperature sensor configured to measure the temperature value, a humidity sensor configured to measure the humidity sensor, a harmful gas sensor configured to measure a concentration value of the harmful gas, an illumination sensor configured to measure illuminance, and a differential pressure sensor configured to measure a pressure distribution within the livestock house.

5. The livestock house management system of claim 2, wherein the data communication unit transmits the command to the livestock house facility control unit according to the wireless communication scheme including an IETF CoAP protocol as the Internet of things (IoT) communication standard and a ZigBee™ communication interface.

6. The livestock house management system of claim 1, wherein the livestock house facility control unit drives the livestock house facility including at least one of a lighting system, a ventilating fan, a spray, and a scraper.

7. The livestock house management system of claim 6, wherein the livestock house facility control unit comprises:
a data communication unit configured to receive the command according to the wireless communication scheme;
a central processor configured to generate a control command for driving the livestock house facility according to the received command; and
a control unit configured to drive the livestock house facility according to the control command.

8. The livestock house management system of claim 7, wherein the data communication unit receives the command according to the wireless communication scheme including an IETF CoAP protocol as the Internet of things (IoT) communication standard and a ZigBee™ communication interface.

9. The livestock house management system of claim 6, wherein the central processor receives a command for controlling power supply to the livestock house facility, a command for controlling illuminance, a color temperature, and dimming of the lighting system, a command for controlling a rotation speed and torque of the ventilating fan, and a command for controlling an operation of the scraper through the data communication unit, and generates the control command corresponding to the received command.

10. The livestock house management system of claim 1, wherein the livestock house is a high-rise poultry house in which a mesh screen spaced apart from a floor by a predetermined height and allowing livestock waste to be dropped to the floor is installed, and the scraper is installed on the floor below the mesh screen.

11. A livestock house management method for managing a rearing environment of livestock, the livestock house management method comprising:
measuring, by an environment monitoring sensor unit installed in each of divided zones within a livestock house, an environment variable indicating a rearing environment situation of each of the zones;
analyzing, by the environment monitoring sensor unit installed in each of the zones, the measured environment variable and determining whether each of the zones is in an abnormal situation;
when the environment monitoring sensor unit determines the abnormal situation, generating a command to handle the abnormal situation and transmitting the command to a livestock house facility control unit installed in each of the zones; and
receiving, by the livestock house facility control unit, the command, and driving a livestock house facility according to the received command to independently control a rearing environment of each of the zones.

12. The livestock house management method of claim 11, wherein the measuring of an environment variable comprises:
measuring the environment variable including at least one of a temperature value, a humidity value, a concentration value of a harmful gas, an illuminance value of each of the zones, a differential pressure value indicating a pressure distribution within the livestock house, and a period of time during which a concentration value of the harmful gas is maintained.

13. The livestock house management method of claim 12, wherein the controlling of a rearing environment of each of the zones comprises:
driving the livestock house facility including at least one of a lighting system, a ventilating fan, a spray, and a scraper according to the received command.

14. The livestock house management method of claim 13, wherein the controlling of a rearing environment of each of the zones comprises:
comparing the period of time during which the concentration value of the harmful gas is maintained with a preset period of time; and
driving the scraper when the period of time during which concentration value of the harmful gas is maintained exceeds the preset period of time.

15. The livestock house management method of claim 11, wherein the transmitting of a command to the livestock facility control unit installed in each of the zones comprises:
generating the command including at least one of a command for controlling power supply to the livestock house facility, a command for controlling illuminance, a color temperature and dimming of the lighting system, a command for controlling a rotation speed and torque of the ventilating fan, and a command for controlling an operation of the scraper.

16. The livestock house management method of claim 11, wherein the transmitting of a command to the livestock facility control unit installed in each of the zones comprises:
transmitting the command to the livestock house facility control unit according to the wireless communication scheme including an IETF CoAP protocol as the Internet of things (IoT) communication standard and a ZigBee™ communication interface.
